(19) United States
(12) Patent Application Publication
(10) Pub. No.: US 2007/0267898 A1
(43) Pub. Date: Nov. 22, 2007

(54) Sun Screen Device Suitable for Large Sunroofs

(75) Inventor: Paul Lin, Yung-Kang City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: MACAUTO INDUSTRIAL CO., LTD., Yung-Kang City, Tainan Hsien (TW)

(21) Appl. No.: 11/419,538

(22) Filed: May 22, 2006

(51) Int. Cl. B60J 7/00

(52) U.S. Cl. 296/214

(57) ABSTRACT

A sun screen device includes first and second shaft units, first and second flexible screen bodies, and first and second battens. The first flexible screen body is wound on the first shaft unit and has an operating end that is movable to a first unwinding position. The first batten is connected to the operating end of the first flexible screen body, and has an end portion. The second flexible screen body is wound on the second shaft unit and has an operating end that is movable to a second unwinding position. The second batten is connected to the operating end of the second flexible screen body, and has an end portion that interfits with the end portion of the first batten when the first and second flexible screen bodies are respectively disposed at the first and second unwinding positions.

### BACKGROUND OF THE INVENTION

1. Field of the Invention

This invention relates to a sun screen device, more particularly to a sun screen device that is suitable for large sunroofs.

2. Description of the Related Art

In U.S. Patent Application Publication No. 2003/0006630, there is disclosed a conventional sun screen device for covering and uncovering a sunroof of an automobile. The conventional sun screen device includes a shaft unit and a flexible screen body. The shaft unit includes a pair of seat members and a shaft member. The shaft member has opposite shaft end portions, each of which is coupled rotatably to a respective one of the seat members. The flexible screen body is wound on the shaft member of the shaft unit. The conventional sun screen device is operable so as to unwind the flexible screen body from the shaft member of the shaft unit to thereby cover the sunroof, and so as to wind the flexible screen body on the shaft member of the shaft unit to thereby uncover the sunroof.

The aforementioned conventional sun screen device is disadvantageous in that when applied to a relatively large sunroof, a large flexible screen body is required to completely block sunlight passing through the sunroof. This makes the operation of the conventional sun screen device difficult.

### SUMMARY OF THE INVENTION

Therefore, the object of the present invention is to provide a sun screen device that can overcome the aforesaid drawback of the prior art.

According to the present invention, a sun screen device for a sunroof of an automobile comprises first and second shaft units, first and second flexible screen bodies, and first and second battens. The sunroof has opposite front and rear sides. The first shaft unit is adapted to be mounted on the front side of the sunroof. The first flexible screen body is wound on the first shaft unit, and has an operating end that is movable to a first unwinding position in a direction toward the rear side of the sunroof to thereby unwind the first flexible screen body from the first shaft unit. The first batten is connected to the operating end of the first flexible screen body, and has an end portion. The second shaft unit is adapted to be mounted on the rear side of the sunroof. The second flexible screen body is wound on the second shaft unit, and has an operating end that is movable to a second unwinding position in a direction toward the front side of the sunroof to thereby unwind the second flexible screen body from the second shaft unit. The second batten is connected to the operating end of the second flexible screen body, and has an end portion that interfits with the end portion of the first batten when the first and second flexible screen bodies are respectively disposed at the first and second unwinding positions.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic view of the first preferred embodiment of a sun screen device according to this invention;

FIG. 2 is a fragmentary, perspective, partly sectional view to illustrate first and second battens of the first preferred embodiment;

FIG. 3 is a fragmentary, partly sectional, schematic view to illustrate a shaft unit of the first preferred embodiment;

FIG. 4 is a fragmentary sectional view of the first preferred embodiment to illustrate a state where the first batten interfits with the second batten; and

FIG. 5 is a fragmentary sectional view of the second preferred embodiment of a sun screen device according to this invention.

### DETAILED DESCRIPTION OF THE PREFERRED EMBODIMENTS

Before the present invention is described in greater detail, it should be noted that like elements are denoted by the same reference numerals throughout the disclosure.

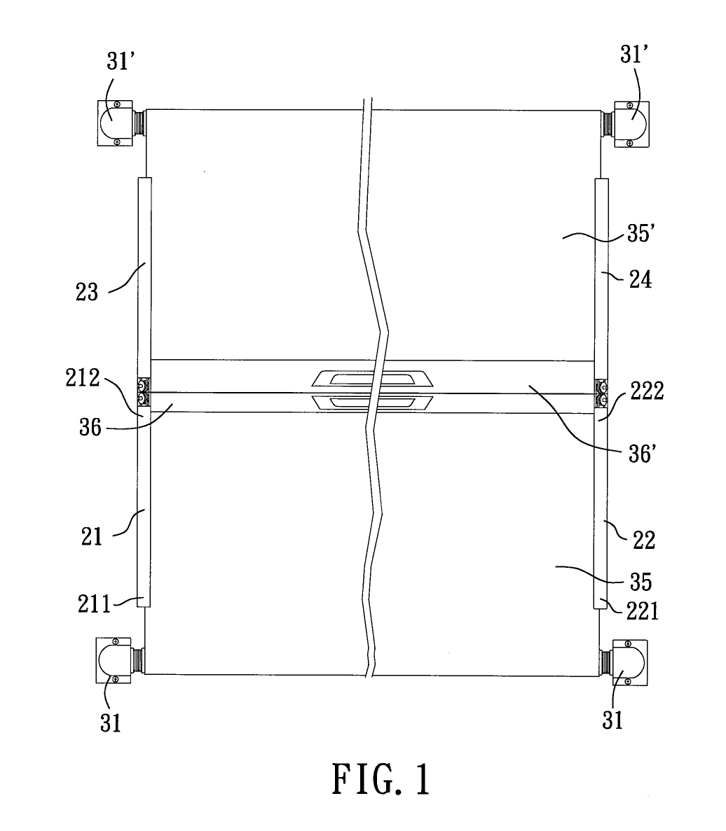

Referring to FIG. 1, the first preferred embodiment of a sun screen device according to this invention is shown to include first and second shaft units, first and second flexible screen bodies 35, 35′, and first and second battens 36, 36′.

The sun screen device of this invention is mounted on a sunroof (not shown) of an automobile (not shown), and is operable so as to cover and uncover the sunroof.

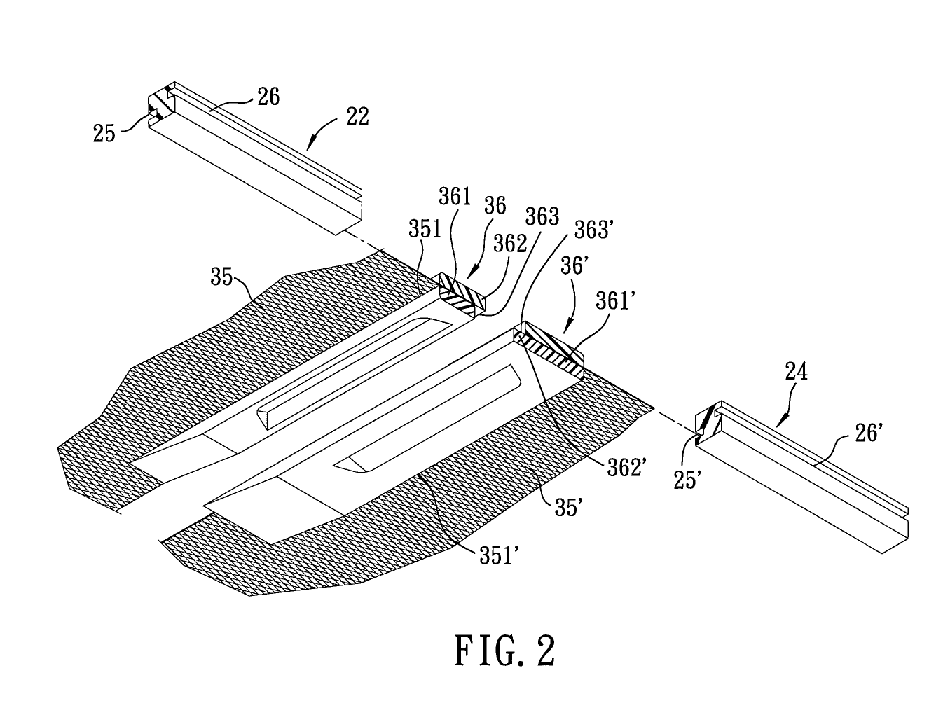

The sun screen device further includes first and second slide rails 21, 22, each of which has opposite first and second rail ends 211, 221, 212, 222, that are disposed respectively at left and right sides (not shown) of the sunroof. With further reference to FIG. 2, each of the first and second slide rails 21, 22 (only the second slide rail 22 is shown in FIG. 2) is formed with first and second rail grooves 25, 26, each of which extends from the first rail end 211, 221 to the second rail end 212, 222 of a respective one of the first and second slide rails 21, 22. The first rail grooves 25 of the first and second slide rails 21, 22 have openings that face toward each other. The second rail grooves 26 of the first and second slide rails 21, 22 have openings that face away from each other.

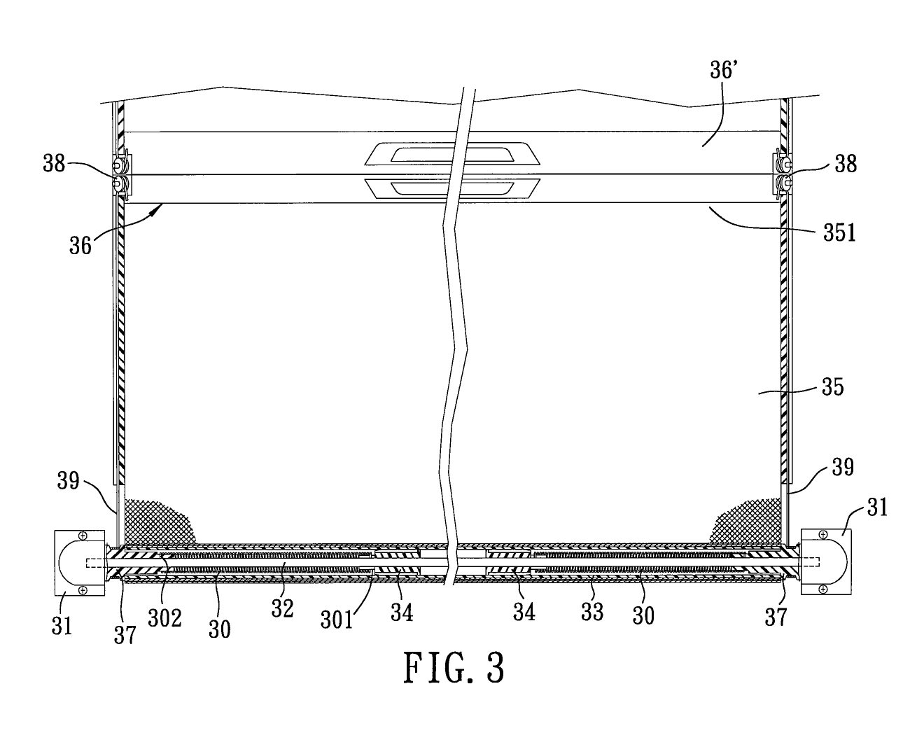

With further reference to FIG. 3, the first shaft unit is disposed on a front side (not shown) of the sunroof, and includes a pair of seat members 31, a shaft member 32, a tubular roller 33, and a pair of coupling members 34. Each of the seat members 31 is disposed proximate to the first rail end 211, 221 of a respective one of the first and second slide rails 21, 22. The shaft member 32 has opposite shaft end portions, each of which is mounted rotatably on a respective one of the seat members 31. The tubular roller 33 is sleeved coaxially on the shaft member 32. The coupling members 34 are disposed in the tubular roller 33, and are connected to the tubular roller 33 and the shaft member 32 of the first shaft unit.

The first flexible screen body 35 is wound on the tubular roller 33 of the first shaft unit, has lateral ends, each of which is disposed in the first rail groove 25 of a respective one of the first and second slide rails 21, 22, and has an operating end 351 that interconnects the lateral ends of the first flexible screen body 35 and that is movable to a first unwinding position in a direction toward the rear side of the sunroof to thereby unwind the first flexible screen body 35 from the tubular roller 33 of the first shaft unit.

The first batten 36 has a first end portion 361 that is connected to the operating end 351 of the first flexible screen body 35, and a second end portion 362 that extends from the first end portion 361 of the first batten 36 and that cooperates with the first end portion 361 to define a step 363.

The first shaft unit further includes a retaining mechanism for retaining the operating end 351 of the first flexible screen body 35 at any arbitrary position along the first and second slide rails 21, 22. In particular, the retaining mechanism of the first shaft unit includes a pair of cord spools 37, a pair of pulleys 38, a pair of pull cords 39, and a pair of spiral spring members 30. Each of the cord spools 37 is mounted rotatably on a respective one of the shaft end portions of the shaft member 32. Each of the pulleys 38 is mounted rotatably on the second rail end 212, 222 of a respective one of the first and second slide rails 21, 22. Each of the pull cords 39 has a first cord section that is wound on a respective one of the cord spools 37, a second cord section that extends from the first cord section and that is disposed in the second rail groove 25 of a respective one of the first and second slide rails 21, 22, a third cord section that extends from the second cord section and that is trained on a respective one of the pulleys 38, and a fourth cord section that extends from the third cord section and that is connected to the first batten 36. Each of the spiral spring members 30 is disposed in the tubular roller 33, is sleeved on the shaft member 32, and has a first end 301 that is connected to a respective one of the coupling members 34, and a second end 302 that is connected to a respective one of the cord spools 37. It is noted that the spiral spring members 30 are pre-tensioned so as to maintain the first flexible screen body 35 and the pull cords 39 in a tautened state.

In operation, when an external force is applied to the first batten 36 such that the operating end 351 of the first flexible screen body 35 is moved from an initial position to the first unwinding position along the first and second slide rails 21, 22, the first flexible screen body 35 unwinds from the tubular roller 33. This results in rotation of the tubular roller 33 in a first angular direction, which in turn, rotates the cord spools 37 in the first angular direction due to torque transmitting action of the spiral spring members 30 to thereby wind the pull cords 39 on the cord spools 37.

Conversely, when an external force is applied to the first batten 36 such that the operating end 351 of the first flexible screen body 35 is moved from the first unwinding position back to the initial position along the first and second slide rails 21, 22, the pull cords 39 unwind from the cord spools 37. This results in rotation of the cord spools 37 in a second angular direction opposite to the first angular direction, which in turn, rotates the tubular roller 33 in the second angular direction due to the spiral spring members 30. Accordingly, the first flexible screen body 35 is wound on the tubular roller 33.

The sun screen device further includes third and fourth slide rails 23, 24, each of which has first and second rail ends 231, 241, 232, 242, that are disposed respectively at the left and right sides of the sunroof. Since the constructions of the third and fourth slide rails 23, 24 are similar to those of the first and second slide rails 21, 22, a detailed description thereof is omitted herein for the sake of brevity.

In this embodiment, the first slide rail 21 is formed separately from the third slide rail 23. Moreover, the second slide rail 22 is formed separately from the fourth slide rail 24. In an alternative embodiment, the first slide rail 21 may be formed integrally with the third slide rail 23. Moreover, the second slide rail 22 may be formed integrally with the fourth slide rail 24.

The second shaft unit is disposed on a rear side (not shown) of the sunroof. Since the construction of the second shaft unit is similar to that of the first shaft unit, a detailed description thereof is omitted herein for the sake of brevity.

The second flexible screen body 35′ is wound on a tubular roller (not shown) of the second shaft unit, has lateral ends, each of which is disposed in a first rail groove 25′ of a respective one of the third and fourth slide rails 23, 24, and has an operating end 351′ that interconnects the lateral ends of the second flexible screen body 35′ and that is movable to a second unwinding position in a direction toward the front side of the sunroof to thereby unwind the second flexible screen body 35′ from the tubular roller of the second shaft unit.

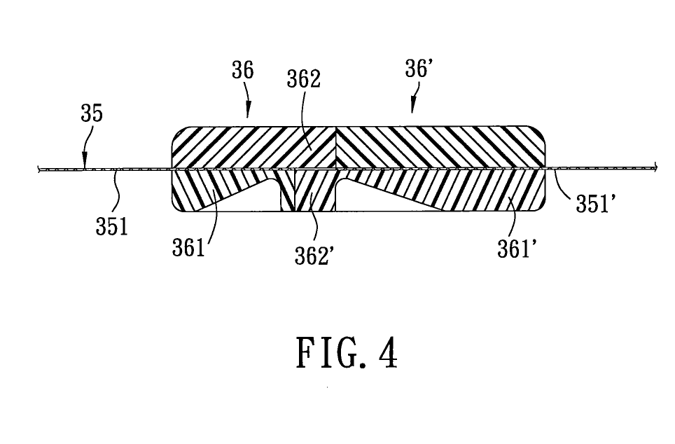

The second batten 36′ has a first end portion 361′ that is connected to the operating end 351′ of the second flexible screen body 35′, and a second end portion 362′ that extends from the first end portion 361′ of the second batten 36′ and that is formed with an overhang 363′ that overlaps the step 363 of the second end portion 362 of the first batten 36 when the first and second flexible screen bodies 35, 35′ are respectively disposed at the first and second unwinding positions, as best shown in FIG. 4.

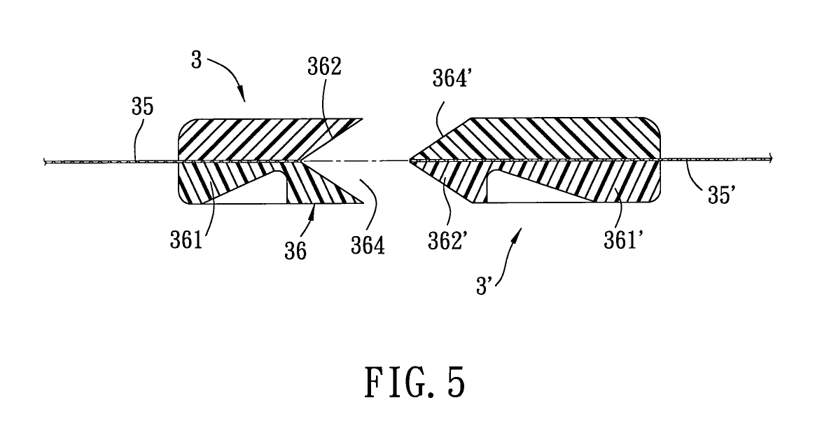

FIG. 5 illustrates the second preferred embodiment of a sun screen device according to this invention. When compared to the previous embodiment, the second end portion 362 of the first batten 36 is formed with an elongate V-shaped groove 364. The second end portion 362′ of the second batten 36′ is formed with an elongate protrusion 364′ that extends into the elongate V-shaped groove 364 in the second end portion 362 of the first batten 36.

It has thus been shown that the sun screen device of this invention includes first and second shaft units, first and second flexible screen bodies 35, 35′, and first and second battens 36, 36′. The first flexible screen body 35 is wound on the first shaft unit and has an operating end 351 that is movable to a first unwinding position. The first batten 36 has a first end portion 361 that is connected to the operating end 351 of the first flexible screen body 35, and a second end portion 362. The second flexible screen body 35′ is wound on the second shaft unit and has an operating end 351′ that is movable to a second unwinding position. The second batten 36′ has a first end portion 361′ that is connected to the operating end 351′ of the second flexible screen body 35′, and a second end portion 362′ that interfits with the second end portion 362 of the first batten 36 such that no gap exists between the first and second battens 36, 36′ when the first and second flexible screen bodies 35, 35′ are respectively disposed at the first and second unwinding positions. Therefore, sunlight passing through the sunroof of the automobile can be completely blocked.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sun screen device for a sunroof of an automobile, the sunroof having opposite front and rear sides, said sun screen device comprising:
a first shaft unit adapted to be mounted on the front side of the sunroof;
a first flexible screen body wound on said first shaft unit, and having an operating end that is movable to a first unwinding position in a direction toward the rear side of the sunroof to thereby unwind said first flexible screen body from said first shaft unit;
a first batten connected to said operating end of said first flexible screen body, and having an end portion;
a second shaft unit adapted to be mounted on the rear side of the sunroof;
a second flexible screen body wound on said second shaft unit, and having an operating end that is movable to a second unwinding position in a direction toward the front side of the sunroof to thereby unwind said second flexible screen body from said second shaft unit; and
a second batten connected to said operating end of said second flexible screen body, and having an end portion that interfits with said end portion of said first batten when said first and second flexible screen bodies are respectively disposed at the first and second unwinding positions.

2. The sun screen device as claimed in claim 1, wherein said end portion of said first batten is formed with a step, said end portion of said second batten being formed with an overhang that overlaps said step of said end portion of said first batten such that no gap exists between said first and second battens when said first and second flexible screen bodies are respectively disposed at the first and second unwinding positions.

3. The sun screen device as claimed in claim 1, wherein said first shaft unit includes a pair of seat members, a shaft member that has opposite shaft end portions, each of which is mounted rotatably on a respective one of said seat members, a tubular roller that is sleeved coaxially on said shaft member and that has said first flexible screen body wound there on, and a coupling member that is disposed in said tubular roller, and that is connected to said tubular roller and said shaft member.

4. The sun screen device as claimed in claim 1, further comprising first and second slide rails, each of which has opposite first and second rail ends and each of which is adapted to be mounted on a respective one of left and right sides of the sunroof, said first shaft unit including
a pair of seat members, each of which is disposed proximate to said first rail end of a respective one of said first and second slide rails,
a shaft member that has opposite shaft end portions, each of which is mounted rotatably on a respective one of said seat members,
a tubular roller that is sleeved coaxially on said shaft member, said first flexible screen body being wound on said tubular roller of said first shaft unit, and
a coupling member that is disposed in said tubular roller, and that is connected to said tubular roller and said shaft member.

5. The sun screen device as claimed in claim 3, wherein said first shaft unit further includes
a cord spool that is mounted rotatably on one of said shaft end portions of said shaft member,
a pulley that is mounted rotatably on said second rail end of one of said first and second slide rails,
a pull cord that is wound on said cord spool, that is trained on said pulley, and that is connected to said first batten, and
a spiral spring member that is disposed in said tubular roller, that is sleeved on said shaft member, and that is connected to said coupling member and said cord spool.

6. The sun screen device as claimed in claim 1, wherein said end portion of said first batten is formed with an elongate groove, said end portion of said second batten being formed with an elongate protrusion that extends into said elongate groove in said end portion of said first batten such that no gap exists between said first and second battens when said first and second flexible screen bodies are respectively disposed at the first and second unwinding positions.
